(19) United States
(12) Patent Application Publication
(10) Pub. No.: US 2011/0075054 A1
(43) Pub. Date: Mar. 31, 2011

(54) EMBEDDED ELECTRONIC DEVICE

(75) Inventors: CHIH-YUAN CHUANG, Tu-Cheng (TW); LIANG-MAO HUNG, Tu-Cheng (TW); JYH-GWO JU, Tu-Cheng (TW); CHIA-PENG WANG, Tu-Cheng (TW); CHUN-WEN WANG, Tu-Cheng (TW); CHIA-HUNG CHIEN, Tu-Cheng (TW)

(73) Assignee: HON HAI PRECISION INDUSTRY CO., LTD., Tu-Cheng (TW)

(21) Appl. No.: 12/632,362

(22) Filed: Dec. 7, 2009

(30) Foreign Application Priority Data
Sep. 28, 2009 (CN) 200910307876.X

(51) Int. Cl. H04N 9/12

(52) U.S. Cl. 348/739; 348/E09.012

(57) ABSTRACT

An embedded electronic device includes a foreground application module, a plurality of system function modules, and a system monitor module. The system monitor module is configured to monitor the working statuses of the plurality of system function modules and to send the working statuses to the foreground application module. The foreground application module is configured to control the plurality of the system function modules via the system monitor module.

### BACKGROUND

1. Technical Field

The present disclosure relates to an embedded electronic device, and particularly, to an embedded electronic device with enhanced content.

2. Description of Related Art

Embedded electronic devices such as digital photo frames (DPF) are becoming increasingly popular due to the convenience and ease of function. However, the typical digital photo frame can only display photos. A digital photo frame with enhanced content is desirable.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a construction view of an embedded electronic device.

FIG. 2 is a schematic view of an embedded electronic device.

FIG. 3 is a schematic view of a main menu of the electronic device of FIG. 1.

FIG. 4 shows implementation of a foreground application in the electronic device of FIG. 1.

FIG. 5 shows termination of the foreground application of FIG. 4.

FIG. 6 is a schematic view of a system monitor module of an embedded electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

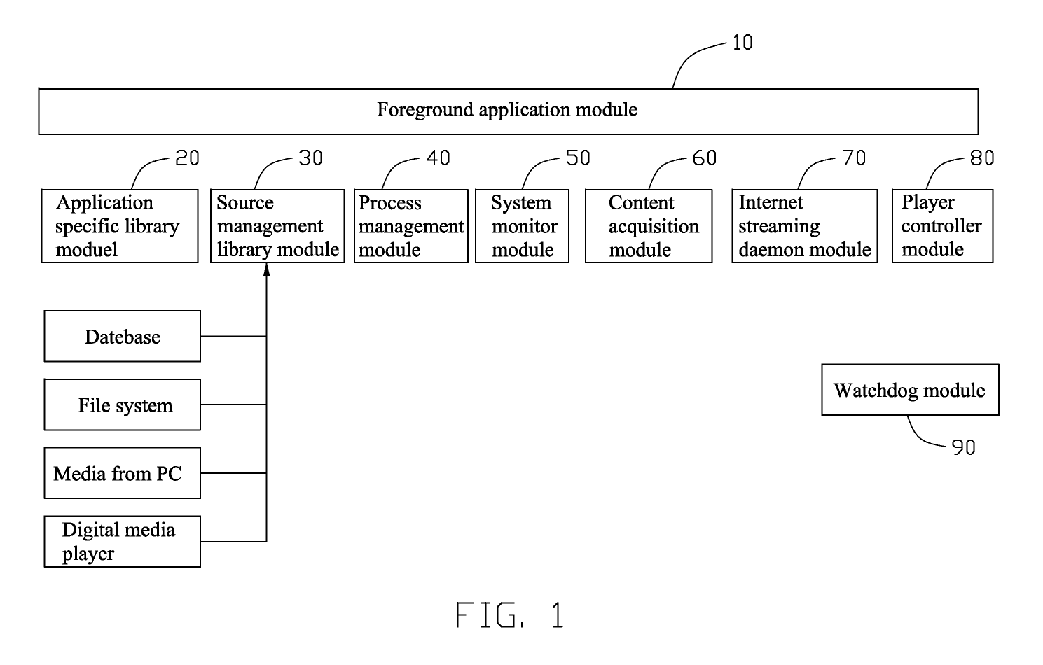

Referring to FIG. 1, an embedded electronic device 100 includes a foreground application module 10, an application specific library module 20, a source management library module 30, a process management module 40, a system monitor module 50, a content acquisition module 60, an internet streaming daemon module 70, a playback controller module 80, and a watchdog module 90. The foreground application module 10 includes a plurality of foreground applications. Each of the modules 10-90 is a standalone process to minimize the effect of individual failure thereof.

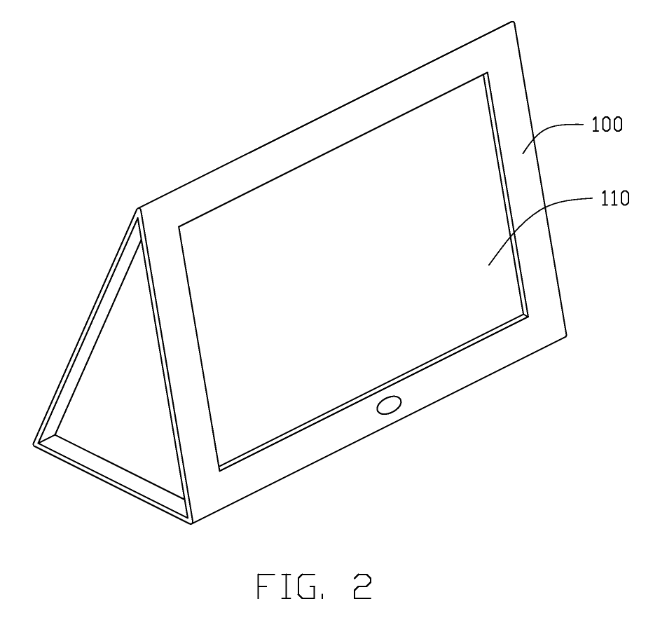

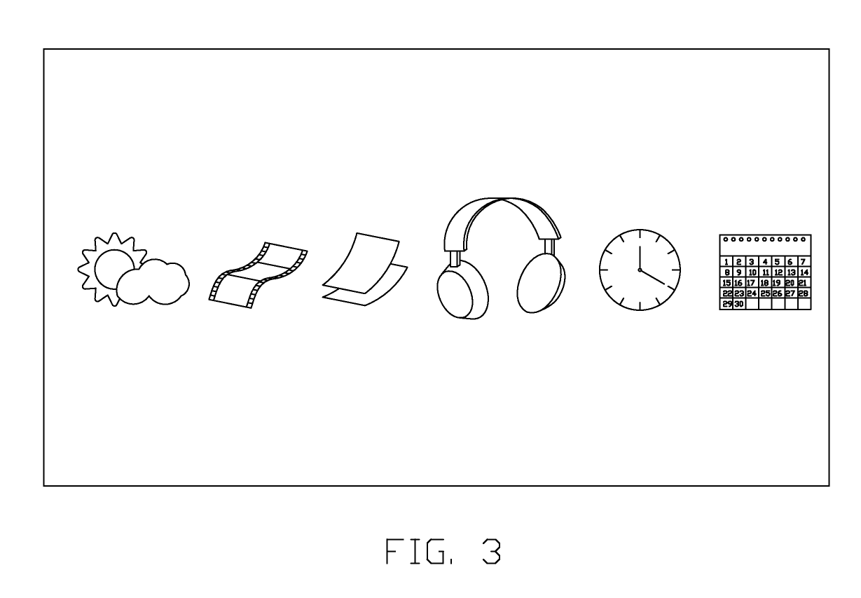

In one exemplary embodiment, and with reference to FIG. 2 and FIG. 3, the embedded electronic device 100 may be a digital photo frame. The embedded electronic device 100 includes a display 110 and a memory. One foreground application dominates the display 110 at a time. In FIG. 3, the display 110 shows a main menu. The main menu may include selections of weather, video, photo, music, calendar, and others. The embedded electronic device 100 also includes a data reader, for example, a secure digital memory (SD) card reader, a compact flash (CF) card reader, an extreme digital (XD) reader, but may also connect to external storage.

The application specific library module 20 hides specific details of a foreground application, such as network protocols of HTTP, awareness of which is not required. Operational commands are received by way of the user interface. The source manager library module 30 retrieves a variety of resources from a range of sources, such as a database, a file system, a personal computer, or a digital media player, and provides the resources to the foreground application module 10.

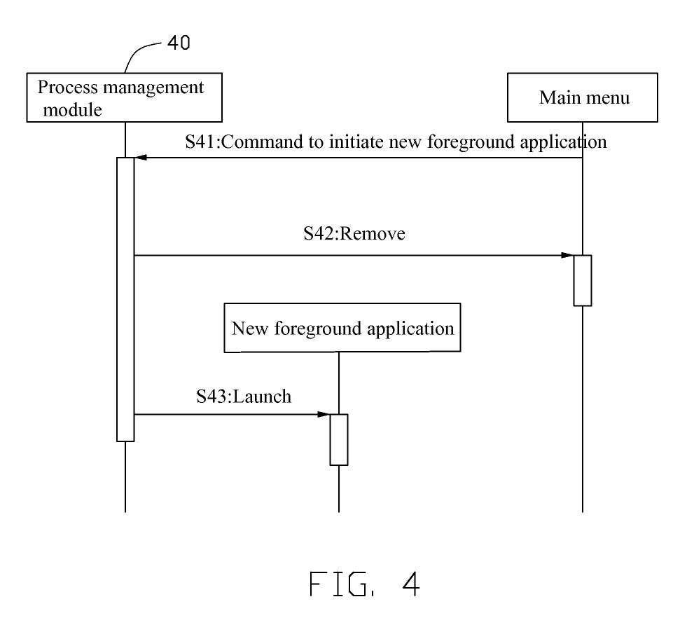

The process management module 40 switches foreground applications, such as launching a foreground application from a main menu displayed on the display 110, returning to the main menu from the foreground application, and/or starting a screen saver or alarm clock. Referring to FIG. 4, a process for launching a foreground application includes following steps.

In step S41, the main menu of the embedded electronic device 100 sends a command to the process management module 40 to initiate a new foreground application.

In step S42, the process management module 40 removes the main menu from view of the display 110.

In step S43, the process management module 40 launches the new foreground application on the embedded electronic device 100.

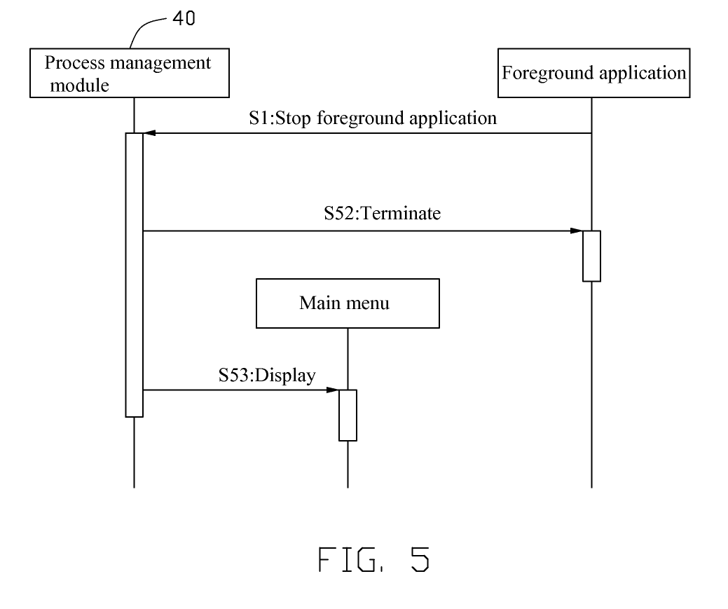

Referring to FIG. 5, when the foreground application is finished, the process for displaying the main menu includes following steps.

In step S51, the foreground application sends an application stop request to the process management module 40.

In step S52, the process management module 40 terminates the foreground application.

In step S53, the process management module 40 displays the main menu on the embedded electronic device 100.

The content acquisition module 60 obtains Internet data for the foreground application module 10. The content acquisition module 60 allows data to be downloaded without interfering with foreground operations.

The Internet streaming daemon module 70 manages the Internet streaming applications, such as acquiring subsequent items in a queue. The playback controller module 80 has an interface for a third party media player providing access to application specific controls such as mute, volume adjustment, file loading, and others. The watchdog module 90 restarts the main menu if the foreground application crashes accidentally, thereby ensuring normal operation of the embedded electronic device 100.

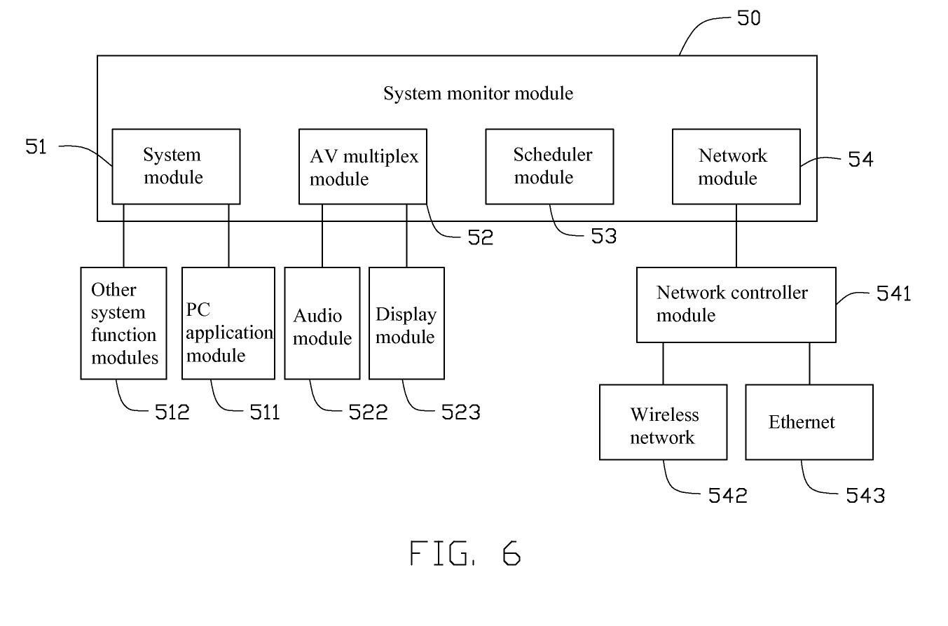

Referring to FIG. 6, the system monitor module 50 includes a system module 51, an audio and video (AV) multiplex module 52, a scheduler module 53, a network module 54, and several system function modules. The several system function modules include an audio module 522, a video module 523, a personal computer (PC) application module 511, and other system function modules 512.

The AV multiplex module 52 is configured to control the audio module 522 and the display module 523. The display module 523 is a Liquid Crystal Display (LCD) display module or a Cathode Ray Tube (CRT) display module. The AV multiplex module 52 controls the output of the audio module 522 by writing Proc files. The AV multiplex module 52 is configured to parse Proc files of the video module 523 to retrieve the current brightness of the video module 523. The AV multiplex module 52 is also configured to write the Proc file to control the brightness.

The system module 51 is configured to monitor the PC application module 511 and the other system function modules 512. The other system function modules 512 includes a touchpad, a G-sensor, a power button, USB devices, real time control (RTC) and so on. The system module 51 is configured to control an LED of the power button by writing Proc files. The system module 51 is configured to detect the current dimension of the device by parsing Proc files of the G-sensor. The system module 51 is configured to determine whether the power button is activated by parsing Proc files of the power button driver, and to control the power LED of the power button by writing Proc files. The system module 51 is configured to query the current system time via the driver ioctl interface. The system module 51 is configured to communicate with the PC application module 511 to accept or reject PC connection request via pipes.

The scheduler module 53 is configured to monitor working statuses of system function modules periodically and transmit the working statuses to the foreground application module 10.

There are message pipes communicating between the foreground application module 10 and the system monitor module 50. The message pipes include an event pipe and a command pipe. The system monitor module 50 transmits information to the foreground application module 10 via the event pipe. The foreground application module 10 transmits commands to the system monitor module 50 via the command pipe.

The network module 54 connects network via a network controller module 541. The network includes wireless network 542 and Ethernet 543.

Message pipes connect the network controller module 541 and the network module 54. The message pipe includes an event pipe and a command pipe. The network controller module 541 transmits information to the network module 54 via the event pipe. The network module 54 transmits commands to the network controller module 541 via the command pipe.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An embedded electronic device, comprising:
a foreground application module;
a plurality of system function modules; and
a system monitor module configured to monitor working statuses of the plurality of system function modules and capable of sending the working statuses to the foreground application module;
wherein the foreground application module is configured to control the plurality of the system function modules via the system monitor module.

2. The embedded electronic device of claim 1, wherein there are message pipes connected between the foreground application module and the system monitor module, the message pipes comprising an event pipe and a command pipe, wherein the event pipe is configured to send the working statuses from the system monitor module to the foreground application module, and the command pipe is configured to send commands from the foreground application to the system monitor.

3. The embedded electronic device of claim 1, wherein the plurality of the system function modules comprises a personal computer application module, the system monitor module comprises a system module configured to receive or reject connection requests from the personal computer application module.

4. The embedded electronic device of claim 1, wherein the plurality of the system function modules comprises a G-sensor module.

5. The embedded electronic device of claim 1, wherein the plurality of the system function modules comprises a power button module.

6. The embedded electronic device of claim 1, wherein the plurality of the system function modules comprises a USB device module.

7. The embedded electronic device of claim 1, wherein the plurality of the system function modules comprises a real time clock module.

8. The embedded electronic device of claim 1, wherein the system monitor module comprises an AV multiplex module, the plurality of the system function modules comprises an audio module and a video module, wherein the AV multiplex module is configured to control the audio module and the video module.

9. The embedded electronic device of claim 1, wherein the system monitor module comprises a scheduler module configured to monitor the working statuses of the plurality of the system function modules periodically and transmit the working statuses to the foreground application module.

10. The embedded electronic device of claim 1, wherein the system monitor module comprises a network module configured to control the network via a network controller module.
